(19) United States
(12) Patent Application Publication
(10) Pub. No.: US 2014/0317272 A1
(43) Pub. Date: Oct. 23, 2014

(54) METHOD OF COLLECTING INFORMATION, CONTENT NETWORK MANAGEMENT SYSTEM, AND NODE APPARATUS USING MANAGEMENT INTERFACE IN CONTENT NETWORK BASED ON INFORMATION-CENTRIC NETWORKING

(71) Applicant: Electronics and Telecommunications Research Institute, Daejeon (KR)

(72) Inventors: Byeongsik KIM, Daejeon (KR); Tae Yeon KIM, Daejeon (KR); Dong Myoung BAEK, Daejeon (KR); Seung Hyun YOON, Daejeon (KR); Byung Joon LEE, Daejeon (KR); Hong Seok JEON, Daejeon (KR); Hyung Seok CHUNG, Daejeon (KR); Ho Young SONG, Daejeon (KR)

(73) Assignee: Electronics and Telecommunications Research Institute, Daejeon (KR)

(21) Appl. No.: 14/096,855

(22) Filed: Dec. 4, 2013

(30) Foreign Application Priority Data
Apr. 18, 2013 (KR) 10-2013-0043129

(51) Int. Cl. H04L 12/24

(52) U.S. Cl. CPC H04L 41/00
USPC 709/224

(57) ABSTRACT

In a content network over which a plurality of smart nodes is coupled, a content network management system receives information response messages including pieces of management interface base (MIB) information from smart nodes. Next, the content network management system classifies the pieces of MIB information included in the received response messages into server resource information, topology information, and network resource information, and stores and manages the pieces of information.

### CROSS-REFERENCE TO RELATED APPLICATION

This application claims priority to and the benefit of Korean Patent Application No. 10-2013-0043129 filed in the Korean Intellectual Property Office on Apr. 18, 2013, the entire contents of which are incorporated herein by reference.

### BACKGROUND OF THE INVENTION

(a) Field of the Invention

The present invention relates to a method of collecting information and, more particularly, to a method of collecting pieces of information necessary to manage a content network based on information-centric networking, and a content network management system and node for performing the method in the content network.

(b) Description of the Related Art

Information-centric networking is a concept that attempts to change an existing Internet communication method in which end-to-end communication is performed between hosts into a paradigm in which communication is performed between hosts based on information. In information-centric networking, each host trying to perform communication does so using an identifier for information to be communicated without using the address of a counterpart host. A network system determines what information has to be served based on an identifier for corresponding information and sends the corresponding information.

A content network is a network that moves content, desired by a user, as close as possible to the user using a caching server, thereby significantly improving transmission speed of the content.

In order to configure a content network, a method of efficiently transferring content data, a method of efficiently storing data in a server and processing data, and a method of efficiently routing content data in order to provide efficient service to a user in addition to simply displacing content to the location of the user are necessary.

However, conventional techniques are very restricted to limited parts, such as a technique for caching content and a technique for routing content, and a method of efficiently processing and managing content in a content network based on information-centric networking is not being developed.

### SUMMARY OF THE INVENTION

The present invention has been made in an effort to provide an information collection method, a content network management system, and a node apparatus using a management interface in a content network based on information-centric networking having an advantage of being capable of efficiently collecting pieces of information necessary to manage the content network.

An exemplary embodiment of the present invention provides a method of collecting information in a content network over which a plurality of smart nodes is coupled. In this method, a content network management system receives information response messages, including pieces of management interface base (MIB) information, from the respective smart nodes, extracts the pieces of MIB information from the received information response messages, classifies the pieces of extracted MIB information into server resource information indicative of the data storage state and throughput of each smart node, topology information indicative of information about a network interface formed in each smart node, and network resource information indicative of bandwidth information about the network interface, and stores the server resource information, the topology information, and the network resource information in respective databases.

The server resource information may include at least one of the total capacity of a data storage unit for storing content, a capacity of the data storage unit that is currently being used, a content identifier, a chunk identifier, a capacity of a processing unit that is being used, the total capacity of a memory, and a capacity of the memory that is being used, for each smart node.

The topology information may include at least one of an identifier for a first interface which is newly formed in a smart node or whose contents have been changed, an IP address of the first interface, an adjacent node interface identifier that is an interface identifier of an adjacent smart node connected to the first interface, and an adjacent node interface IP address that is an IP address for an interface of the smart node connected to the first interface.

The network resource information may include at least one of a total bandwidth for an interface which is newly formed in a smart node or whose contents have been changed, and an available bandwidth for the interface.

The method may further include the content network management system generating pieces of information request messages that request the pieces of MIB information in a predetermined information collection cycle and sequentially sending the pieces of information request messages to the plurality of smart nodes connected to the content network, before receiving the information response messages.

The method may further include the content network management system selecting a smart node from which information is to be requested from the plurality of the smart nodes and generating an information request message and sending the generated information request message to the selected smart node, before receiving the information response message.

The method may further include each smart node determining whether or not its own MIB information has been changed, generating the information response message including the changed MIB information if, as a result of the determination, the MIB information has been changed, and sending the generated information response message to the content network management system, before receiving the information response message.

Another embodiment of the present invention provides a system for collecting information in a content network over which a plurality of smart nodes is coupled. The system includes an information collection client for generating information request messages for collecting pieces of MIB information from the smart nodes and receiving information response messages from the respective smart nodes in response to the information request messages, a server resource database for storing pieces of server resource information each indicative of the data storage state and throughput of each smart node, from among the pieces of collected MIB information, a topology information database for storing pieces of topology information each indicative of information about a network interface formed in each smart node, from among the pieces of collected MIB information, and a network resource information database for storing pieces of network resource information each indicative of bandwidth information about the network interface, from among the pieces of collected MIB information.

The information collection client may generate the information request messages in a predetermined information collection cycle, and request pieces of information from the plurality of smart nodes by sequentially sending the generated information request messages to the respective smart nodes.

The information collection client may send the information request message to a smart node from which information needs to be collected, and receive the information response message as a response to the information request message from the smart node.

The information collection client may receive the information response message autonomously transmitted by a smart node without sending the information request message to the smart node, and process the received information response message.

The information collection client may extract the pieces of MIB information from the received information response messages, classify the pieces of extracted MIB information into the pieces of server resource information, the pieces of topology information, and the pieces of network resource information, store the pieces of information in the respective databases, and manage the stored information.

Yet another embodiment of the present invention provides a node apparatus connected to a content network over which a plurality of smart nodes is coupled. The node apparatus includes an MIB unit for processing server resource information indicative of the data storage state and throughput, topology information indicative of information about a network interface formed in the node apparatus, and network resource information indicative of bandwidth information about the network interface in a form of MIB information and storing the MIB information, and an information collection and processing unit for generating an information response message including the MIB information and sending the generated information response message to a content network management system.

The information collection and processing unit may receive an information request message from the content network management system in a predetermined information collection cycle, generate the information response message in response to the information request message, and send the generated information response message.

The information collection and processing unit may receive an information request message transmitted by the content network management system and configured to comprise an identifier of the node apparatus, generate the information response message in response to the information request message, and send the generated information response message to the content network management system.

The information collection and processing unit may generate the information response message including changed MIB information when the MIB information is changed, and send the generated information response message to the content network management system.

### BRIEF DESCRIPTION OF THE DRAWINGS

FIG. 1 is a diagram showing a content network based on information-centric networking in accordance with an exemplary embodiment of the present invention.

FIG. 2 is a schematic view showing the information collection process of a content network management system in accordance with an exemplary embodiment of the present invention.

FIG. 3 is a diagram showing that pieces of information are stored in an MIB form in accordance with an exemplary embodiment of the present invention.

FIG. 4 shows the structure of a content network management system in accordance with an exemplary embodiment of the present invention.

FIG. 5 shows the structure of a smart node in accordance with an exemplary embodiment of the present invention.

FIG. 6 is a flowchart illustrating a method of collecting information in accordance with a first exemplary embodiment of the present invention, and

FIG. 7 is a diagram showing a message transmission and reception relationship between the content network management system and the smart node in accordance with a first exemplary embodiment of the present invention.

FIG. 8 is a flowchart illustrating a method of collecting information in accordance with a second exemplary embodiment of the present invention, and

FIG. 9 is a diagram showing a message transmission and reception relationship between the content network management system and the smart node in accordance with a second exemplary embodiment of the present invention.

FIG. 10 is a flowchart illustrating a method of collecting information in accordance with a third exemplary embodiment of the present invention, and

FIG. 11 is a diagram showing a message transmission and reception relationship between the content network management system and the smart node in accordance with a third exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

In the entire specification and claims, unless explicitly described to the contrary, the word “comprise” and variations such as “comprises” or “comprising” will be understood to imply the inclusion of stated elements but not the exclusion of any other elements.

A method and apparatus for collecting information in a content network in accordance with exemplary embodiments of the present invention are described below.

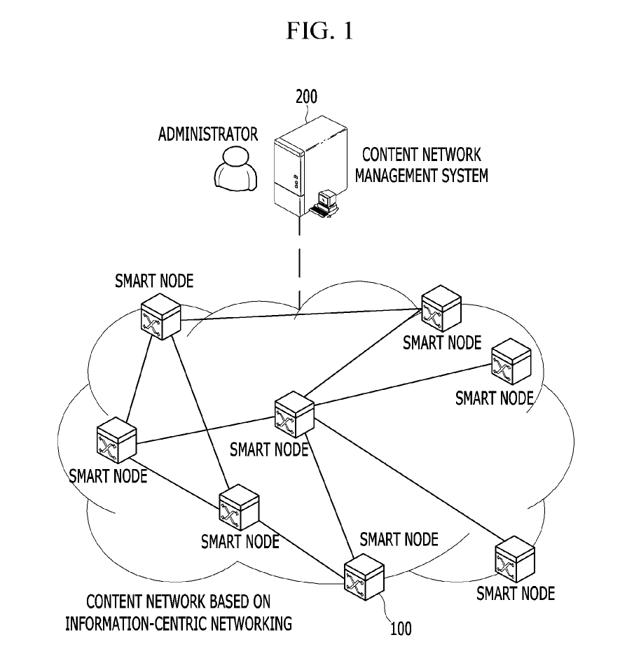

FIG. 1 is a diagram showing a content network based on information-centric networking in accordance with an exemplary embodiment of the present invention.

As shown in FIG. 1, the content network includes a plurality of smart nodes (assigned a representative number “100”) and a content network management system 200 connected to the smart nodes.

The content network management system 200 is a separate system that enables an operator to manage a content network based on information-centric networking. The content network management system 200 collects pieces of information necessary to manage a content network based on information-centric networking, and manages the content network based on information-centric networking based on the pieces of collected information. The content network management system 200 may perform control over a content network based on information-centric networking.

The smart node 100 sends content based on an identifier. The smart node 100 can perform a server function of storing high-capacity content and a function of caching content located in another smart node for users located nearby in addition to the function of sending content based on an identifier.

The smart node 100 can further perform a method of efficiently transferring content data, a method of efficiently storing data in a server and processing data, and a method of efficiently routing content data in order to provide efficient service to a user.

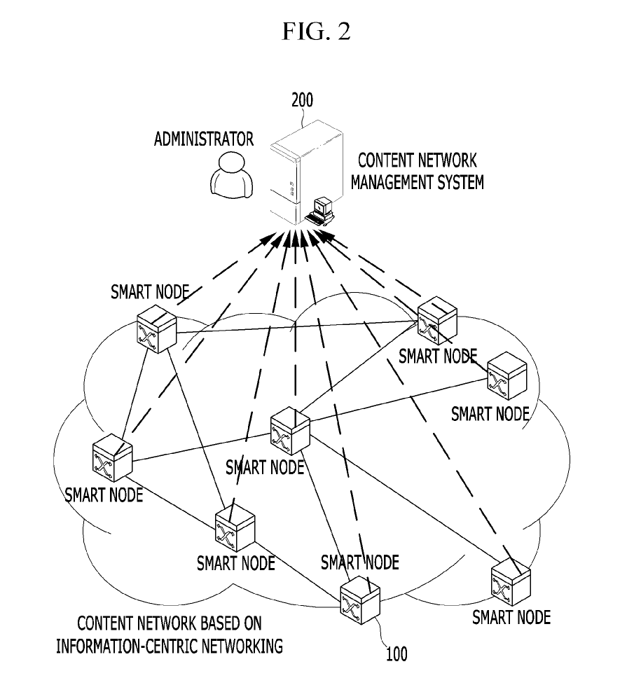

FIG. 2 is a schematic view showing the information collection process of the content network management system 200 in accordance with an exemplary embodiment of the present invention.

The content network management system 200, as shown in FIG. 2, collects pieces of information using the management interfaces of smart nodes. More particularly, the content network management system 200 collects information about the topology of a content network, information about network resources of the content network, and information about resources of the smart nodes.

In this network environment, the smart node 100 in accordance with an exemplary embodiment of the present invention processes and stores pieces of information necessary for the content network management system 200 in a management information base form. The pieces of information are as follows.

TABLE 1

| Information | |
|---|---|
| identifier | Description |
| Total_Datastore | Total capacity of smart node data storage unit |
| Used_Datastore | Capacity of smart node data storage unit that is |
| | currently being used |
| Content_ID | Identifiers of pieces of content stored in smart node |
| | data storage unit |
| Chunk_ID | Identifiers of chunks stored in smart node caching |
| | storage unit |
| Used_CPU | Capacity of smart node processor (CPU) used |
| Total_Memory | Total capacity of smart node memory |
| Used_Memory | Capacity of smart node memory that is currently being |
| | used |
| Inf | Pieces of information about network interfaces |

Here, pieces of information “Inf” about network interfaces include pieces of information, such as those listed in Table 2.

TABLE 2

| Information | |
|---|---|
| identifier | Description |
| Inf_ID | Identifier for interface (e.g., interface name, such as |
| | “eth0”) |
| Inf_IP | IP address for interface |
| Neighbor_IF | Interface identifier of adjacent smart node connected to |
| | corresponding interface |
| Neighbor_IP | IP address for interface of neighbor smart node |
| | connected to corresponding interface |
| Total_BW | Total bandwidth for physical communication link |
| | connected to corresponding interface |
| Available_BW | Available bandwidth for interface |

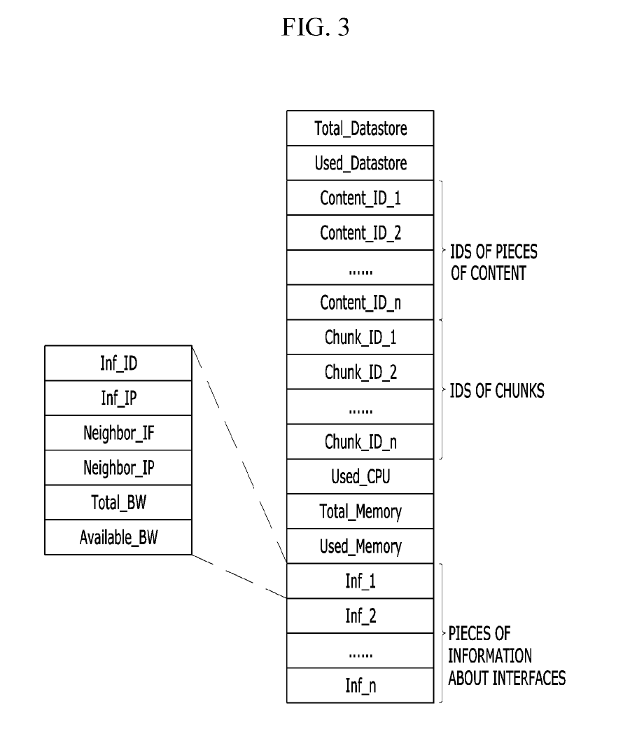

FIG. 3 is a diagram showing that pieces of information are stored in an MIB form in accordance with an exemplary embodiment of the present invention.

The pieces of information listed in Table 1 and Table 2 can be stored in an MIB form as shown in FIG. 3, and Total_Datastore, Used_Datastore, Content_ID_{—}1, Content_ID_{—}2, . . . , Content_ID_n, Chunk_ID_{—}1, Chunk_ID_{—}2, . . . , Chunk_ID_n, Used_CPU, Total_Memory, Used_Memory, and Inf_{—}1, Inf_{—}2, . . . , Inf_n are sequentially stored so that the data storage state and throughput of each smart node can be checked.

Here, each of Inf_{—}1, Inf_{—}2, . . . , Inf_n includes Inf_ID, Inf_IP, Neighbor_IF, Neighbor_IP, Total_BW, and Available_BW for each interface.

Each of the smart nodes includes an MIB storage unit for storing the pieces of information. The pieces of information stored in the MIB storage unit, such as those shown in FIG. 3, are hereinafter called “pieces of MIB information”, for convenience sake.

The content network management system 200 requests MIB information from each smart node, and stores and manages pieces of MIB information received as a response to the request. Particularly, the content network management system 200 in accordance with an exemplary embodiment of the present invention classifies pieces of MIB information received from smart nodes, and stores and manages the pieces of classified MIB information. More particularly, the content network management system 200 classifies the pieces of collected MIB information into server resource information, topology information, and network resource information, stores the pieces of classified information in corresponding databases, and manages the pieces of classified information.

The server resource information includes the total capacity of a data storage unit for storing content “Total_Datastore”, a capacity of the data storage unit that is currently being used “Used_Datastore”, content identifiers “Content_IDs”, chunk identifiers “Chunk_IDs”, a capacity of a processing unit used “Used_CPU”, the total capacity of memory “Total_Memory”, and a capacity of memory that is being used “Used_Memory”, from among pieces of MIB information.

The topology information indicates information about a network interface formed in each smart node. The topology information includes an identifier for a corresponding interface “Inf_ID” which is newly formed or whose contents have been changed, the IP address of the corresponding interface “Inf_IP”, the interface identifier of an adjacent smart node connected to the corresponding interface, that is, an adjacent node interface identifier “Neighbor_IF”, and an IP address for the interface of the adjacent smart node connected to the corresponding interface, that is, an adjacent node interface IP address “Neighbor_IP”, from among pieces of information that form “Inf”, that is, information related to the network interface of MIB information.

The network resource information indicates information about the bandwidth of a network interface and includes a total bandwidth “Total_BW” for a corresponding interface and an available bandwidth “Available_BW” for the corresponding interface, from among pieces of information that form “Inf”, that is, information related to the network interface of MIB information.

The content network management system 200 stores the server resource information, the topology information, and the network resource information in respective databases and manages the pieces of information.

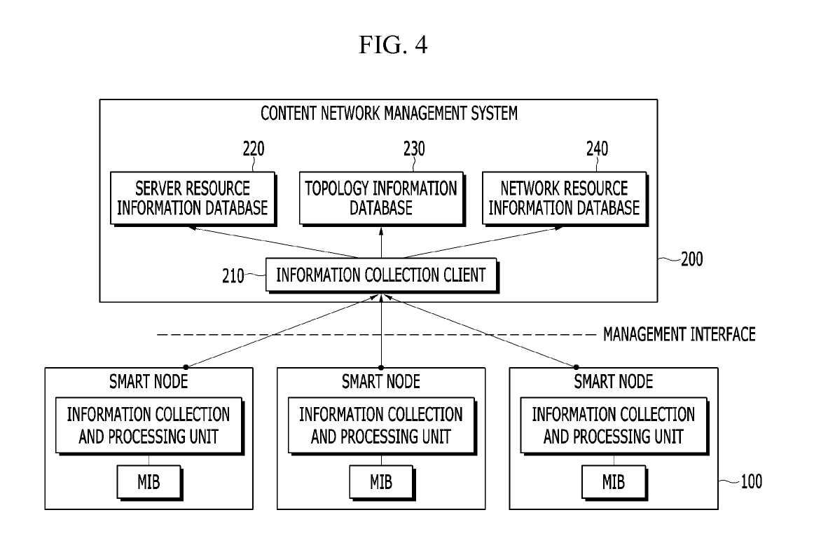

FIG. 4 shows the structure of a content network management system in accordance with an exemplary embodiment of the present invention, and also shows an information collection relationship between the content network management system and the smart node.

As shown in FIG. 4, the content network management system 200 in accordance with an exemplary embodiment of the present invention includes an information collection client 210 for requesting pieces of MIB information from smart nodes and receiving the pieces of MIB information, a server resource information database 220 for storing only pieces of server resource information from among the pieces of collected MIB information, a topology information database 230 for storing only pieces of topology information from among the pieces of collected MIB information, and a network resource information database 240 for storing only pieces of network resource information from among the pieces of collected MIB information.

The information collection client 210 may periodically request information from the smart nodes in a polling manner, or may request information from the smart nodes in an on-demand manner when information is necessary. A method of collecting information is described in more detail below.

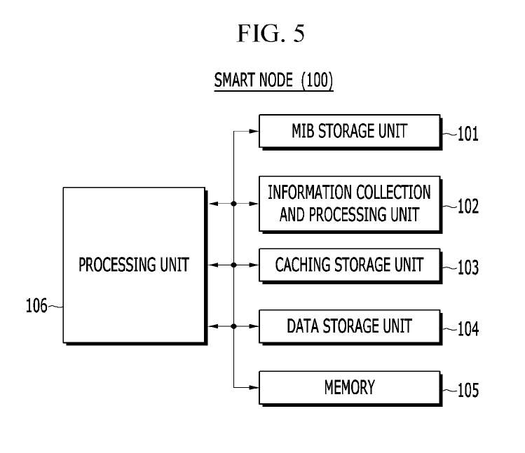

Each smart node provides information to the information collection client 210 in response to an information request from the information collection client 210 of the content network management system 200. To this end, the smart node has a structure such as that of FIG. 5.

FIG. 5 shows the structure of the smart node in accordance with an exemplary embodiment of the present invention.

A node apparatus in accordance with an exemplary embodiment of the present invention, that is, the smart node 100, includes an MIB storage unit 101 for storing and managing MIB information, and an information collection and processing unit 102 for providing the MIB information stored in the MIB storage unit 101 in response to an information request from the content network management system 200, as shown in FIG. 5.

As shown in FIG. 5, the smart node 100 further includes a caching storage unit 103 for receiving content in a chunk unit and caching the received content, a data storage unit 104 for storing data (including content) collected and managed by the smart node, a memory 105, and a processing unit 106 for controlling the elements 101, 102, 103, and 104 and the memory 105 for content processing and message transmission/reception processing in the smart node. The caching storage unit 103 performs a function of caching content for user terminals located nearby. The processing unit 106 performs a function of sending content based on an identifier.

A method of collecting information based on the above-described construction in accordance with an exemplary embodiment of the present invention is described below.

The content network management system 200 in accordance with an exemplary embodiment of the present invention can request information from the smart node using the following three methods.

In the first method, the information collection client 210 periodically polls the information collection and processing unit 102 of the smart node 100 in order to collect information. In the second method, the information collection client 210 requests information from the information collection and processing unit 102 of a smart node from which the information needs to be collected in an on-demand manner and receives the information. In the third method, the information collection client 210 of the content network management system 200 does not play the role of a main entity for requesting management information, but the information collection and processing unit 102 of the smart node 100 inserts pieces of changed information into a management information response message and sends the management information response message to the information collection client 210 in a trap manner when there is a change of MIB information managed by a corresponding node.

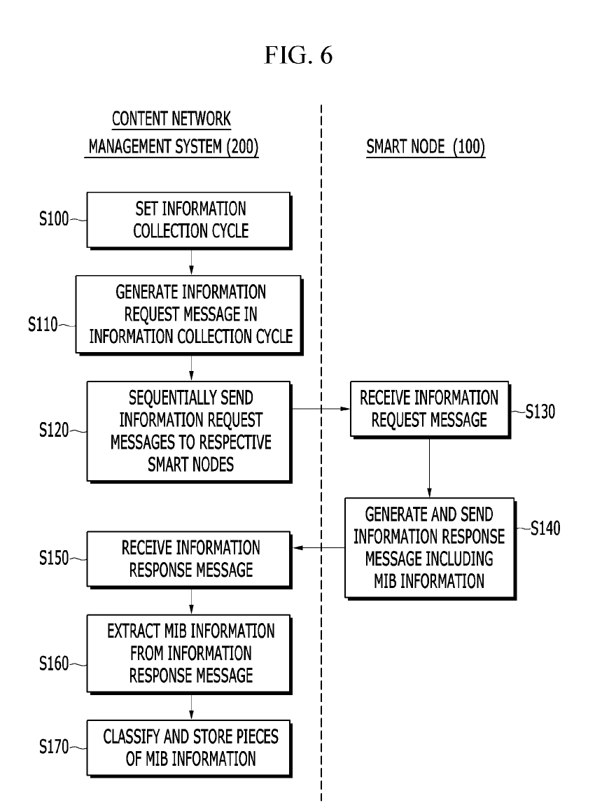

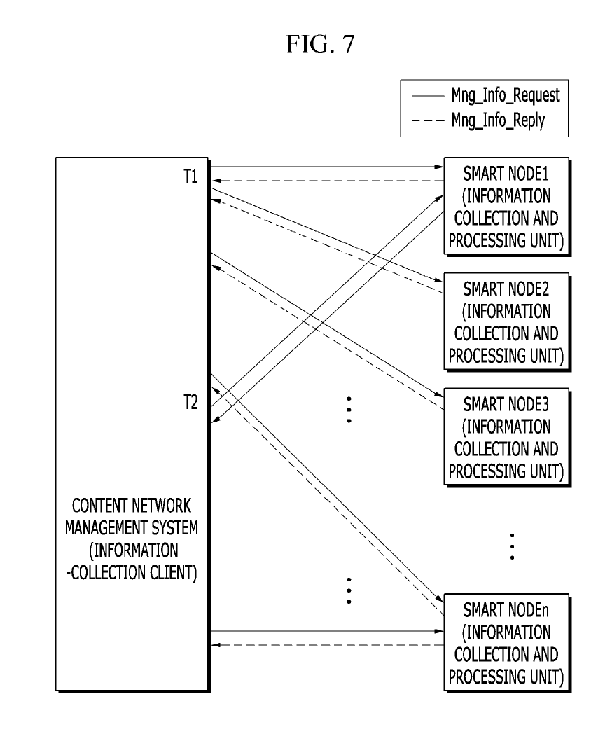

FIG. 6 is a flowchart illustrating a method of collecting information in accordance with a first exemplary embodiment of the present invention, and FIG. 7 is a diagram showing a message transmission and reception relationship between the content network management system and the smart node in accordance with a first exemplary embodiment of the present invention.

In the first exemplary embodiment of the present invention, information is collected according to the first method.

As shown in FIG. 6, the information collection client 210 of the content network management system 200 collects pieces of information in a predetermined cycle. The predetermined cycle is hereinafter referred to as an “information collection cycle”, for convenience sake. The information collection cycle is previously set at step S100.

When the information collection cycle (e.g., T1 in FIG. 7) is reached, the information collection client 210 of the content network management system 200 generates an information request message “Mng_Info_Request” that requests MIB information at step S110, and sends the generated information request message to the smart node 100 at step S120. The information request message can include an identifier for the smart node.

Here, the information collection client 210 can sequentially generate information request messages and send the generated information request messages to the respective smart nodes. For example, as shown in FIG. 7, when the information collection cycle T1 is reached, the information collection client 210 can generate an information request message and send the generated information request message to a smart node 1. Next, the information collection client 210 can sequentially generate information request messages and send the generated information request messages to a smart node 2, a smart node 3, . . . , a smart node n, respectively.

Each of the smart nodes receives the information request message from the information collection client 210 of the content network management system 200 at step S130, generates an information response message “Mng_Info_Reply” including MIB information managed by each smart node, and sends the generated information response message to the information collection client 210 at step S140. For example, as shown in FIG. 7, the information response messages can be transmitted in order of the smart node 1, the smart node 2, the smart node 3, . . . , the smart node n in order of the received information request messages. Here, the information response message can include an identifier for each smart node.

The information collection client 210 receives the pieces of information response message from the smart node 100 at step S150, extracts pieces of MIB information from the information response messages at step S160, and classifies the pieces of extracted MIB information into server resource information, topology information, and network resource information at step S170. Furthermore, the information collection client 210 stores pieces of the classified server resource information in the server resource information database 220, pieces of the classified topology information in the topology information database 230, and pieces of the classified network resource information in the network resource information database 240 and manages the pieces of information.

When a next information collection cycle (e.g., a second information collection cycle T2 in FIG. 7) is reached, the information collection client 210 sequentially generates information request messages, sends the generated information request messages to the smart nodes, and requests pieces of MIB information from the smart nodes.

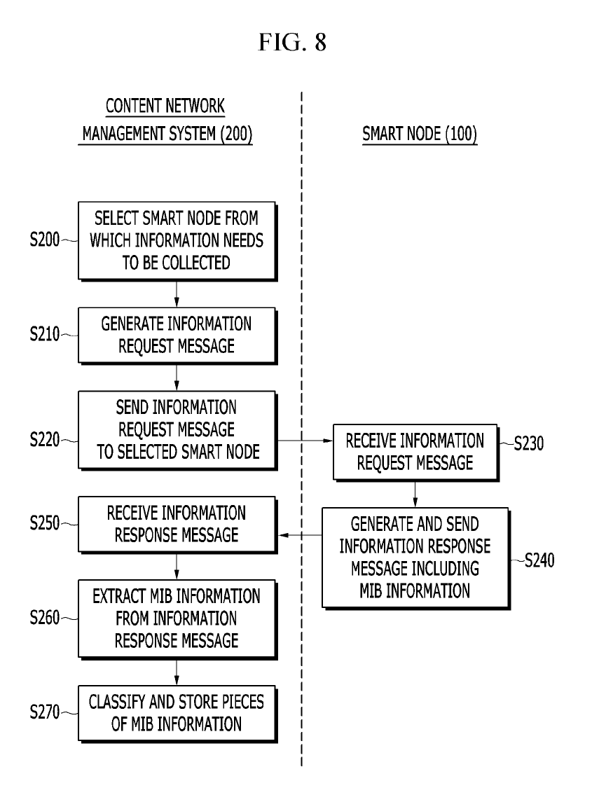

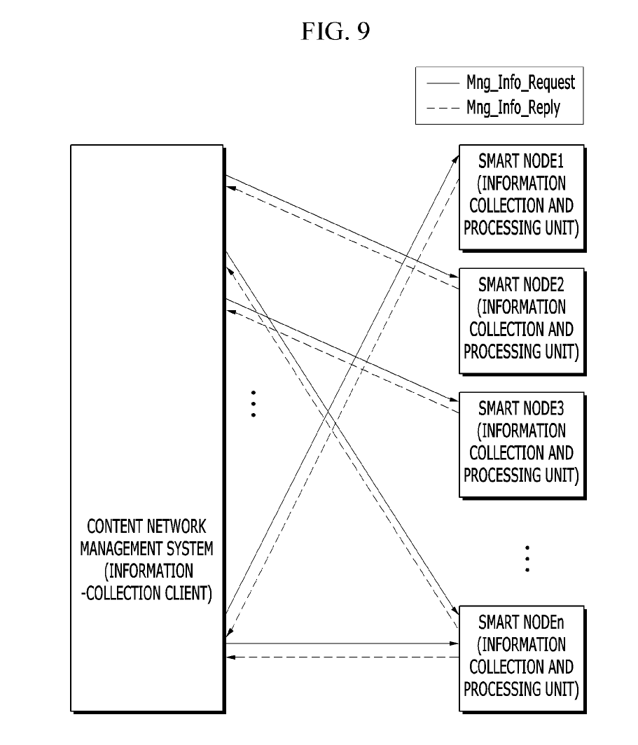

FIG. 8 is a flowchart illustrating a method of collecting information in accordance with a second exemplary embodiment of the present invention, and FIG. 9 is a diagram showing a message transmission and reception relationship between the content network management system and the smart node in accordance with a second exemplary embodiment of the present invention.

In the second exemplary embodiment of the present invention, information is collected according to the second method.

As shown in FIG. 8, the information collection client 210 of the content network management system 200 selects a smart node from which information needs to be collected at step S200. Furthermore, the information collection client 210 generates an information request message Mng_Info_Request that requests MIB information at step S210, and sends the generated information request message to the selected smart node (e.g., a smart node 2 in FIG. 9) at step S220. Here, the information request message can include an identifier for the selected smart node.

The selected smart node 200 receives the information request message from the information collection client 210 of the content network management system 200 at step S230, and generates an information response message Mng_Info_Reply including MIB information managed by the selected smart node 200 and sends the generated information response message to the information collection client 210 at step S240. For example, as shown in FIG. 9, if the smart node 2 has received the information request message, the information collection and processing unit 102 of the smart node 2 obtains MIB information from the MIB storage unit 101, includes the obtained MIB information in the information response message, and sends the information response message to the information collection client 210. Here, the information response message can include an identifier for the smart node.

The information collection client 210 receives the information response message from the selected smart node at step S250, extracts the MIB information from the received information response message at step S260, and classifies pieces of the extracted MIB information into server resource information, topology information, and network resource information at step S270. Furthermore, the information collection client 210 stores pieces of the classified server resource information in the server resource information database 220, pieces of the classified topology information in the topology information database 230, and pieces of the classified network resource information in the network resource information database 240 and manages the pieces of information.

As described above, the information collection client 210 can collect information by performing the above-described process on a smart node from which the information needs to be collected.

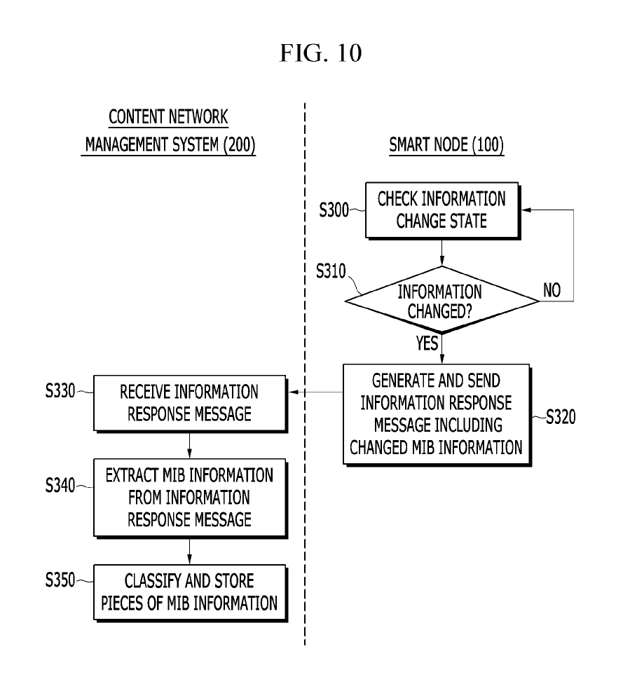

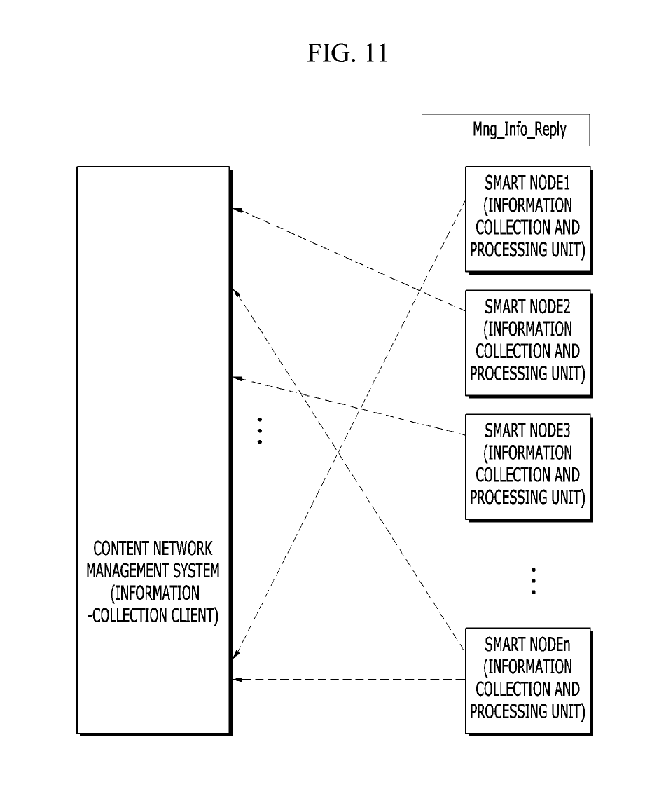

FIG. 10 is a flowchart illustrating a method of collecting information in accordance with a third exemplary embodiment of the present invention, and FIG. 11 is a diagram showing a message transmission and reception relationship between the content network management system and the smart node in accordance with a third exemplary embodiment of the present invention.

In the third exemplary embodiment of the present invention, information is collected according to the third method (i.e., a trap method).

As shown in FIG. 10, if MIB information managed by the smart node 100 is changed in response to an event, such as a new link being set up or a change of information about a link at steps S300 and S310, the smart node 100 generates an information response message including the changed MIB information.

For example, as shown in FIG. 11, a smart node 2 can generate the information response message, including an identifier “Inf_ID” for an interface which is newly formed or whose contents have been changed, the IP address of the interface “Inf_IP”, an adjacent node interface identifier “Neighbor_IF”, an adjacent node interface IP address “Neighbor_IP”, the total bandwidth “Total_BW” for the interface, and an available bandwidth “Available_BW” for the interface.

The smart node 100 generates the information response message including the changed MIB information and sends the generated information response message to the information collection client 210 at step S320.

The information collection client 210 receives the information response message from the smart node 100 at step S330, extracts the MIB information from the received information response message at step S340, and classifies pieces of the extracted MIB information into server resource information, topology information, and network resource information at step S350. Furthermore, the information collection client 210 stores pieces of the classified server resource information in the server resource information database 220, pieces of the classified topology information in the topology information database 230, and pieces of the classified network resource information in the network resource information database 240 and manages the pieces of information.

As described above, a smart node including changed MIB information can autonomously generate an information response message and send the generated information response message to the information collection client 210 of the content network management system 200.

The content network management system 200 in accordance with an exemplary embodiment of the present invention can maintain pieces of MIB information about a current network and retain desired up-to-date information in a database through the above-described methods of collecting information.

In accordance with an exemplary embodiment of the present invention, information about the resources of smart nodes and information about the topology and network resources of a content network can be integrally collected in a content network based on information-centric networking, and the entire content network can be managed and controlled based on pieces of the information.

The exemplary embodiments of the present invention are not only implemented by way of the method and/or the apparatus, but may be implemented by way of a program for realizing a function corresponding to a construction according to an exemplary embodiment of the present invention or a recording medium on which the program is recorded. The implementations will be evident to a person having ordinary skill in the art to which the present invention pertains from the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of collecting information in a content network over which a plurality of smart nodes is coupled, the method comprising:
a content network management system receiving information response messages, comprising pieces of management interface base (MIB) information, from the respective smart nodes;
the content network management system extracting the pieces of MIB information from the received information response messages; and
the content network management system classifying the pieces of extracted MIB information into server resource information indicative of a data storage state and throughput of each smart node, topology information indicative of information about a network interface formed in each smart node, and network resource information indicative of bandwidth information about the network interface, and storing the server resource information, the topology information, and the network resource information in respective databases.

2. The method of claim 1, wherein the server resource information comprises at least one of a total capacity of a data storage unit for storing content, a capacity of the data storage unit that is currently being used, a content identifier, a chunk identifier, a capacity of a processing unit that is being used, a total capacity of a memory, and a capacity of the memory that is being used, for each smart node.

3. The method of claim 1, wherein the topology information comprises at least one of an identifier for a first interface which is newly formed in a smart node or whose contents have been changed, an IP address of the first interface, an adjacent node interface identifier that is an interface identifier of an adjacent smart node connected to the first interface, and an adjacent node interface IP address that is an IP address for an interface of the smart node connected to the first interface.

4. The method of claim 1, wherein the network resource information comprises at least one of a total bandwidth for an interface which is newly formed in a smart node or whose contents have been changed, and an available bandwidth for the interface.

5. The method of claim 1, further comprising,
before receiving the information response messages:
the content network management system generating pieces of information request messages that request the pieces of MIB information in a predetermined information collection cycle; and
the content network management system sequentially sending the pieces of information request messages to the plurality of smart nodes connected to the content network.

6. The method of claim 1, further comprising,
before receiving the information response message:
the content network management system selecting a smart node from which information is to be requested from the plurality of smart nodes; and
the content network management system generating an information request message and sending the generated information request message to the selected smart node.

7. The method of claim 1, further comprising,
before receiving the information response message:
each smart node determining whether or not its own MIB information has been changed; and
the smart node generating the information response message comprising the changed MIB information if, as a result of the determination, the MIB information has been changed, and sending the generated information response message to the content network management system.

8. A content network management system for collecting information in a content network over which a plurality of smart nodes is coupled, comprising:
an information collection client for generating information request messages for collecting pieces of management interface base (MIB) information from the smart nodes and receiving information response messages from the respective smart nodes in response to the information request messages;
a server resource database for storing pieces of server resource information each indicative of a data storage state and throughput of each smart node, from among the pieces of collected MIB information;
a topology information database for storing pieces of topology information each indicative of information about a network interface formed in each smart node, from among the pieces of collected MIB information; and
a network resource information database for storing pieces of network resource information each indicative of bandwidth information about the network interface, from among the pieces of collected MIB information.

9. The content network management system of claim 8, wherein the information collection client generates the information request messages in a predetermined information collection cycle, and requests pieces of information from the plurality of smart nodes by sequentially sending the generated information request messages to the respective smart nodes.

10. The content network management system of claim 8, wherein the information collection client sends the information request message to a smart node from which information needs to be collected, and receives the information response message as a response to the information request message from the smart node.

11. The content network management system of claim 8, wherein the information collection client receives the information response message autonomously transmitted by a smart node without sending the information request message to the smart node, and processes the received information response message.

12. The content network management system of claim 8, wherein the information collection client extracts the pieces of MIB information from the received information response messages, classifies the pieces of extracted MIB information into the pieces of server resource information, the pieces of topology information, and the pieces of network resource information, stores the pieces of information in the respective databases, and manages the stored information.

13. A node apparatus connected to a content network over which a plurality of smart nodes is coupled, comprising:
a management interface base (MIB) unit for processing server resource information indicative of a data storage state and throughput, topology information indicative of information about a network interface formed in the node apparatus, and network resource information indicative of bandwidth information about the network interface in a form of MIB information and storing the MIB information; and
an information collection and processing unit for generating an information response message comprising the MIB information and sending the generated information response message to a content network management system.

14. The node apparatus of claim 13, wherein the information collection and processing unit receives an information request message from the content network management system in a predetermined information collection cycle, generates the information response message in response to the information request message, and sends the generated information response message.

15. The node apparatus of claim 13, wherein the information collection and processing unit receives an information request message transmitted by the content network management system and configured to comprise an identifier of the node apparatus, generates the information response message in response to the information request message, and sends the generated information response message to the content network management system.

16. The node apparatus of claim 13, wherein the information collection and processing unit generates the information response message comprising changed MIB information when the MIB information is changed, and sends the generated information response message to the content network management system.
